(19) United States
(12) Patent Application Publication
(10) Pub. No.: US 2008/0053419 A1
(43) Pub. Date: Mar. 6, 2008

(54) Low-idle exhaust gas recirculation system

(75) Inventor: David Andrew Pierpont, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/513,104

(22) Filed: Aug. 31, 2006

(51) Int. Cl. F02M 25/07; F02D 41/00

(52) U.S. Cl. 123/676; 123/568.21

(57) ABSTRACT

An exhaust recirculation system is provided for reducing NOx emitted from the power source at low-idle speeds. The power source has at least one combustion chamber, an intake manifold, a first exhaust manifold, and a second exhaust manifold. The exhaust recirculation system has a valve located in at least one of the first or second exhaust manifolds. The valve is moveable to increase the temperature of an exhaust gas by directing exhaust gas from the at least one of the first and second exhaust manifolds to the intake manifold. Furthermore, the exhaust recirculation system has a controller configured to determine at least one power source condition indicative of an exhaust temperature and move the valve in response to the determination.

### TECHNICAL FIELD

The present disclosure is directed generally to an exhaust gas recirculation system, and more particularly, to an exhaust gas recirculation system for low-idle nitrous oxide reduction.

### BACKGROUND

Internal combustion engines, including diesel engines, gasoline engines, natural gas engines, and other engines known in the art may exhaust a complex mixture of air pollutants. The air pollutants are composed of solid particulate matter and gaseous compounds including nitrous oxides (NOx). Due to increased attention on the environment, exhaust emission standards have become more stringent, and the amount of solid particulate matter and gaseous compounds emitted to the atmosphere from an engine is regulated depending on the type of engine, size of engine, and/or class of engine.

Several methods have been implemented by engine manufacturers to comply with the regulation of these engine emissions. One method includes utilizing catalytic devices such as selective catalytic reduction (SCR) systems, NOx reducing catalytic chambers, and oxidation catalytic chambers. These devices operate by mixing a chemical catalyst with exhaust gas produced by the engine to transform much of the existing pollutants into harmless elements such as water and nitrogen. Another method includes using an exhaust gas recirculating (EGR) system. EGR systems operate by recirculating a portion of the exhaust gas back to the intake of the engine. There, the exhaust gas mixes with fresh air. The resulting mixture contains less oxygen than pure air, thus lowering the combustion temperature in the combustion chambers and producing less NOx. Simultaneously, some of the particulate matter contained within the exhaust is burned upon re-introduction to the combustion chamber. Both methods can be effectively used in combination to comply with engine emission standards.

When operating at low-idle, an engine can produce a significant amount of NOx and particulate matter, which can be difficult to expunge. Unfortunately, catalytic devices are not effective when an engine is operating at low-idle because the temperature of the exhaust flowing through the devices is too low. Catalytic devices are only effective above a minimum threshold temperature. Furthermore, using a conventional EGR system alone may be insufficient to reduce the large amount of NOx created at low-idle speeds. At low-idle, the exhaust gas also contains a large amount of particulate matter because the temperature of the exhaust is too low to combust the particulate matter contained therein. Thus, when a typical EGR system is operating at low-idle to reduce NOx, the system reintroduces too much particulate matter into the engine hurting engine efficiency without sufficiently reducing the output level of NOx.

One attempt to address this issue is disclosed in U.S. Pat. No. 6,112,729, issued to Barnes et al. (hereinafter the '729 patent). The '729 patent discloses disabling the EGR system during certain engine operating conditions including when the engine is cold and when the engine is operating at low-idle for an extended period of time. Disabling the EGR system prevents it from reintroducing excessive amounts of particulate matter into the engine that reduces engine efficiency.

While the method of the '729 patent may improve engine efficiency at low-idle speeds, it may not sufficiently reduce NOx emissions enough to meet the increasingly stringent environmental regulations. The method allows the exhaust temperature to fall below the operating temperature of the catalytic devices during low-idle speeds rendering the catalytic devices inoperable. A disabled EGR system along with inoperable catalytic devices can create a situation where the engine produces more NOx than regulations allow. Furthermore, in order to remain compliant in these situations, the remaining portions of an engine's operating cycle must be overly restricted such that the total engine operating cycle is compliant. By overly restricting the remaining portion of the engine's operating cycle, the efficiency of the engine may be reduced even more.

The present disclosure is directed at overcoming one or more of the problems or disadvantages in the prior art.

### SUMMARY OF THE INVENTION

In one aspect, the present disclosure is directed toward an exhaust recirculation system that includes a power source. The power source has at least one combustion chamber, an intake manifold, a first exhaust manifold, and a second exhaust manifold. In addition, the exhaust recirculation system includes a valve located in at least one of a first and second exhaust manifolds. The valve is moveable to increase the temperature of an exhaust gas by directing exhaust gas from the at least one of the first and second exhaust manifolds to the intake manifold. Furthermore, the exhaust recirculation system includes a controller configured to determine at least one power source condition indicative of an exhaust temperature and move the valve in response to the determination.

Consistent with a further aspect of the disclosure, a method is also provided for recirculating exhaust gas. The method includes sensing at least one power source condition indicative of an exhaust gas temperature. In addition, the method includes redirecting exhaust from a power source back into the power source in response to the exhaust gas temperature.

### BRIEF DESCRIPTION OF THE DRAWINGS

FIG. 1 is a diagrammatic illustration of a power system according to an exemplary disclosed embodiment of the present disclosure; and

FIG. 2 is a flow chart depicting an exemplary method of operating the power system of FIG. 1.

### DETAILED DESCRIPTION

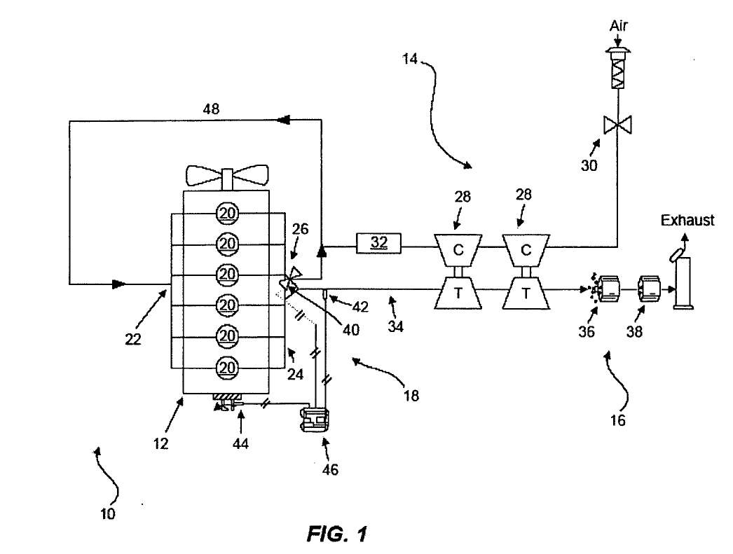

FIG. 1 illustrates an exemplary power system 10 having an engine 12 configured to combust a mixture of air and fuel and generate a mechanical output and a flow of exhaust. Power system 10 may also include an air system 14, an exhaust treatment system 16, and an exhaust gas recirculating (EGR) system 18. Air system 14 may supply air to engine 12 to facilitate the combustion process. Exhaust treatment system 16 may reduce the pollutants released by engine 12 into the atmosphere. EGR system 18, may recirculate a portion of an exhaust gas produced by engine 12 back to an intake of engine 12.

Engine 12 may be any kind of conventional diesel, gasoline, or gaseous fuel-powered internal combustion engine and may include at least one combustion chamber 20, an intake manifold 22, a first exhaust manifold 24, and a second exhaust manifold 26. Intake manifold 22 may direct air from system 14 to combustion chambers 20. The exhaust produced during the combustion process within combustion chamber 20 may exit engine 12 via either first exhaust manifold 24 or second exhaust manifold 26.

In an exemplary embodiment illustrated in FIG. 1, first exhaust manifold 24 and second exhaust manifold 26 may each be operationally connected to three combustion chambers 20. However, it is contemplated that first exhaust manifold 24 and second exhaust manifold 26 may each be operationally connected to any number of combustion chambers 20 so long as both manifolds are operationally connected to at least one combustion chamber 20 and that all combustion chambers 20 are operationally connected to either first exhaust manifold 24 or second exhaust manifold 26. It is further contemplated that engine 12 may include a single, integral manifold, if desired.

Air system 14 may supply air to intake manifold 22 and may include one or more air compressing devices 28 for introducing charged air into combustion chambers 20 of engine 12, a throttle valve 30 for regulating the flow of air, and an air cooler 32 for cooling the air. Air compressing devices 28 may include, for example, turbochargers and/or superchargers. Throttle valve 30 may be located upstream of the compressing devices 28 to regulate the flow of air into engine 12. It is contemplated that compressing devices 28 may be omitted and engine 12 may alternatively be naturally aspirated. It is also contemplated that additional and/or different components may be included within the air induction systems such as, for example one or more air cleaners, one or more waste gates, a bypass system, a control system, and other means known in the art for introducing charged air into combustion chambers 20. Air cooler 32 may be located upstream of where EGR system 18 ties into the air intake of engine 12, such that the exhaust gas directed to engine 12 remains at an elevated temperature.

Exhaust treatment system 16 may reduce the amount of pollutants released by engine 12 into the atmosphere. Exhaust treatment system 16 may be operationally connected to first exhaust manifold 24 and second exhaust manifold 26 via a common passage 34. In the exemplary embodiment of FIG. 1, exhaust treatment system 16 may include one or more after-treatment devices such as a particulate filter 36 and a lean NOx catalytic device 38. It is contemplated that additional exhaust treatment devices may be used to reduce NOx such as selective catalytic reduction devices and/or any other NOx reducing devices known in the art.

Particulate filter 36 may include filter elements (not shown) designed to trap particulate matter. Particulate filter 36 may also include an electric heating element (not shown) or fuel injector (not shown) to burn off particulate matter that may accumulate on the filter elements and restrict exhaust gas flow through the filter.

NOx catalytic device 38 may effectively operate when the exhaust temperature is above approximately 200 degrees Celsius. The chemical properties of the catalysts present in the catalytic devices may allow the catalyst to react with the NOx in the exhaust at temperatures above 200 degrees Celsius. However, if the exhaust temperature is below 200 degrees Celsius, the chemical catalysts may not react or react poorly with the particulate matter. As a result, the exhaust may pass through the catalytic devices without substantial purging of NOx.

EGR system 18 may recirculate a portion of the exhaust gas from engine 12 back to intake manifold 22 and may include an EGR valve 40, a temperature sensor 42, an engine speed sensor 44, and a controller 46. EGR valve 40 may be a simple on/off valve or a proportional-type valve and may be fluidly connected to second exhaust manifold 26, common passage 34, and an EGR passage 48. Upon receiving a signal from controller 46, EGR valve 40 may direct the exhaust gas from second exhaust manifold 26 to either exhaust treatment system 16 via common passage 34 or intake manifold 22 via EGR passage 48. It is contemplated that EGR valve 40 may be associated with both first and second exhaust manifolds, if desired.

In order to determine when to activate EGR valve 40, it may be necessary to ascertain the physical state of engine 12. This may be accomplished through the detection of certain physical parameters of engine 12 via sensors 42 and 44. Specifically, sensor 42 may be configured to produce one or more signals indicative of exhaust manifold temperature. In addition, sensor 44 may be configured to produce signals indicative of engine speed. It is contemplated that sensors 42 and 44 may be disposed at any location relative to first exhaust manifold 24, second exhaust manifold 26, and engine 12, respectively, and are shown at particular locations for exemplary purposes only.

Temperature sensor 42 may be any type of temperature sensor mounted within first exhaust manifold 24, second exhaust manifold 26, or common passage 34 to sense the temperature of the exhaust gas exiting chambers 20. For example, temperature sensor 42 may embody a surface-type temperature sensor that measures a wall temperature of first exhaust manifold 24, second exhaust manifold 26, or common passage 34. Alternately, temperature sensor 42 may be a gas-type temperature sensor that directly measures the temperature of the exhaust gas within first exhaust manifold 24, second exhaust manifold 26, or common passage 34. Temperature sensor 42 may generate an exhaust gas temperature signal and send this signal to controller 46 via a communication line (not referenced) as is known in the art. This temperature signal may be sent continuously, on a periodic basis, or only when prompted to do so by controller 46.

Engine speed sensor 44 may sense a speed of engine 12. For example, engine speed sensor 44 may embody a magnetic pickup sensor configured to sense a rotational speed of a crankshaft (not referenced) of engine 12 and to produce a signal corresponding to the rotational speed. Engine speed sensor 44 may be disposed proximal a magnetic element (not shown) embedded within the crankshaft (not referenced), proximal a magnetic element (not shown) embedded within a component directly or indirectly driven by the crankshaft (not referenced), or in other suitable manner to produce a signal corresponding to the rotational speed of engine 12. The power source speed signal may be sent to controller 46 by way of a communication line (not referenced) as is known in the art. It may be contemplated that temperature sensor 42 may be omitted if engine speed sensor 44 is utilized to determine exhaust gas temperature.

In an alternate embodiment, it is contemplated that controller 46 may utilize other sensory input as a substitute for the temperature signal and/or the engine speed signal, if desired. Such input may be associated with various engine parameters, such as, for example, fuel consumption rate, engine throttle position, intake manifold temperature, boost pressure, fuel setting, air flow, and/or any other parameter known in the art. Controller 46 may receive and analyze this input to derive the exhaust manifold temperature and/or engine speed of engine 12.

Controller 46 may include one or more microprocessors, a memory, a data storage device, a communication hub, and/or other components known in the art. In an exemplary embodiment illustrated in FIG. 1, controller 46 may be associated with only EGR system 18. However, it is contemplated that controller 46 may be integrated within a general control system capable of controlling additional functions of power system 10, e.g., selective control of engine 12, and/or additional systems operatively associated with power system 10, e.g., selective control of a transmission system.

Controller 46 may receive signals from sensors 42 and 44 and analyze the data to determine whether engine 12 is operating in a low-idle condition by comparing the data to threshold temperature and speed values stored in or accessible by controller 46. Upon receiving input signals from sensors 42 and 44, controller 46 may perform a plurality of operations, e.g., algorithms, equations, subroutines, reference look-up maps or tables, and establish an output to influence the operation of EGR valve 40 via one or more communication lines (not referenced) as is known in the art.

### INDUSTRIAL APPLICABILITY

The disclosed EGR system may provide a simple, inexpensive, and reliable way to reduce NOx and particulate emissions released into the atmosphere during low-idle conditions. In particular, the disclosed EGR system may utilize an exhaust gas recirculating valve to redirect exhaust gas back into the intake manifold of an engine in response to a temperature of the exhaust gas and/or a speed of the engine. Redirecting the exhaust gas back into the intake manifold may lead to the exhaust gas temperature remaining above a threshold temperature critical for optimal performance of catalytic NOx reduction devices. The operation of power system 10 will now be explained.

Air from air system 14 may enter engine 12 through intake manifold 22. Once inside combustion chambers 20, the air may be compressed and then mixed with fuel such as diesel, gasoline, or natural gas (not shown). Once combined, the mixture may combust to produce a mechanical output and a flow of exhaust gas. The exhaust gas may enter either first exhaust manifold 24 or second exhaust manifold 26 via exhaust outlet 28 depending on the configuration of combustion chambers 20.

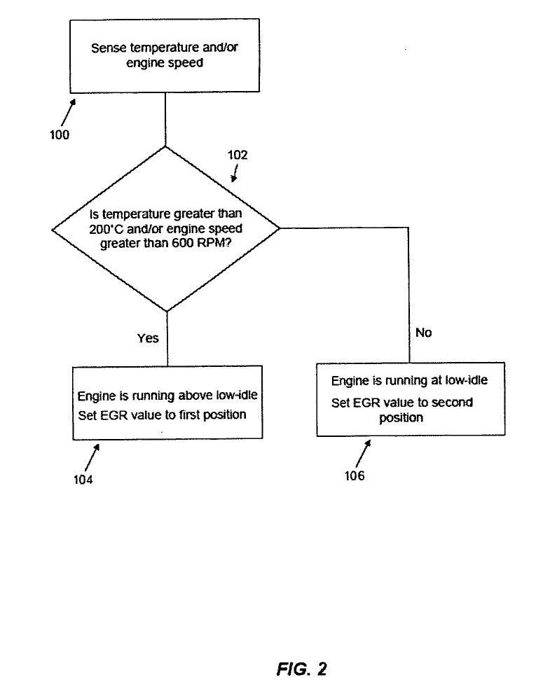

As is illustrated by the method disclosed in FIG. 2, at step 100, sensors 42 and 44 may sense the temperature of the exhaust gas in one of the exhaust manifolds and/or sense the engine speed. Sensors 42 and 44 may then transmit signals based on the exhaust gas temperature and/or engine speed to controller 46. At step 102, controller 46 may receive the signals from sensors 42 and 44 and may determine whether the exhaust gas temperature and/or engine speed are above or below predetermined thresholds, e.g., 600 RPM and 200 degrees Celsius respectively. Controller 46 may make this determination by performing algorithms, referencing a look-up map, or follow other techniques well-known in the art.

Step 104 may be performed if controller 46 determines that engine 12 is operating at speeds greater than low-idle. Controller 46 may draw this conclusion if the exhaust gas temperature and/or engine speed are above the predetermined thresholds. During step 104, controller 46 may move EGR valve 40 to a first position at which exhaust gas from second exhaust manifold 26 is directed via common passage 34 to exhaust treatment system 16. In addition, exhaust gas in first exhaust manifold 24 may enter exhaust treatment system 16 via common passage 34. Once in exhaust treatment system 16, NOx in the exhaust gas may react with a catalyst in a catalytic chamber reducing the amount of NOx before it is released into the atmosphere.

Step 106 may be performed if controller 46 determines that engine 12 is operating at speeds lower than low-idle. Controller 46 may draw this conclusion if the exhaust gas temperature and/or engine speed are below the predetermined thresholds. During step 106, controller 46 may move EGR valve 40 to a second position at which exhaust gas from second exhaust manifold 26 is directed to inlet manifold 22 via EGR passage 48. In inlet 22, exhaust gas from second exhaust manifold 26 may mix with fresh air from air system 14. The exhaust gas may raise the temperature of the exhaust gas/air mixture entering engine 12 and may ultimately increase the temperature of the exhaust gas entering exhaust treatment system 16. Once in exhaust treatment system 16, NOx in the exhaust gas may react with a catalyst in a catalytic chamber reducing the amount of NOx before it is released into the atmosphere.

Because the disclosed system may direct exhaust gas to the engine intake based on exhaust manifold temperature and/or engine speed, it may be ensured that the emission of NOx at low temperature and/or low speed conditions remains within regulations. Specifically, directing exhaust back to the engine intake may increase the exhaust gas temperature, which may allow the after-treatment catalytic devices to function at low temperature and/or low speed conditions. In addition, utilizing the EGR and catalytic systems during low temperature and low speed conditions may improve the exhaust treatment efficiency of the power system because the NOx reducing devices will perform properly over the entire spectrum of engine conditions instead of only at high-speed and above low-idle conditions. It should also be noted that because low-idle exhaust emissions are improved, restrictions at other speed conditions may be relaxed to further improve engine efficiency throughout the operating cycle.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. An exhaust recirculation system comprising:
a power source including at least one combustion chamber, an intake manifold, a first exhaust manifold, and a second exhaust manifold;
a valve located in at least one of the first and second exhaust manifolds and moveable to increase the temperature of an exhaust gas by directing exhaust gas from the at least one of first and second exhaust manifolds to the intake manifold; and
a controller configured to determine at least one power source condition indicative of an exhaust temperature and move the valve in response to the determination.

2. The exhaust recirculation system of claim 1, further including a first sensor located in the at least one of the first and second exhaust manifolds and configured to measure a temperature of the exhaust, wherein the controller is in communication with the first sensor to receive a temperature signal.

3. The exhaust recirculation system of claim 2, wherein the controller is configured to move the valve to a position at which exhaust gas from the at least one of the first and second exhaust manifolds flows to the intake manifold when the signal indicates the temperature of the exhaust gas being below a threshold temperature.

4. The exhaust recirculation system of claim 3, wherein the threshold temperature is approximately 200 degrees Celsius.

5. The exhaust recirculation system of claim 2, wherein a second sensor is located to sense a speed of the power source.

6. The exhaust recirculation system of claim 5, wherein the controller is configured to move the valve to a position at which exhaust gas flows from the at least one of the first and second exhaust manifolds to the intake manifold when the temperature of the exhaust gas falls below a threshold temperature and the speed of the power source falls below a threshold speed.

7. The exhaust recirculation system of claim 6, wherein the threshold temperature is approximately 200 degrees Celsius and the threshold speed is approximately 600 RPM.

8. The exhaust recirculation system of claim 1, wherein the valve is disposed within only the second exhaust manifold.

9. The exhaust recirculation system of claim 1, further including a sensor configured to sense a non-temperature parameter of the power source and generate a parameter signal indicative of the non-temperature parameter, wherein the controller is in communication with the sensor and is configured to derive the exhaust gas temperature value from the parameter signal.

10. A method for recirculating exhaust gas comprising:
sensing at least one power source condition indicative of an exhaust gas temperature; and
redirecting exhaust from a power source back into the power source in response to the exhaust gas temperature.

11. The method of claim 10, wherein redirecting includes directing exhaust gas from the power source back into the power source when the temperature of the exhaust gas is below a threshold temperature.

12. The method of claim 11, wherein the threshold temperature is approximately 200 degrees Celsius.

13. The method of claim 11, wherein the power source condition is a speed of the power source and redirecting includes directing exhaust gas from the power source back into the power source when the speed falls below a threshold speed.

14. The method of claim 13, wherein the threshold speed is approximately 600 RPM.

15. The method of claim 11, further including sensing a speed of the power source, wherein the step of redirecting is in further response to a speed of the power source.

16. A power system comprising:
an engine including at least one combustion chamber, an intake manifold, a first exhaust manifold, and a second exhaust manifold;
an air system including at least one air compressor and an air cooler in fluid communication with the intake manifold;
an exhaust treatment system including an after-treatment device fluidly connected to the first and second exhaust manifolds, the after-treatment device having a minimum operating temperature;
an exhaust recirculation system including a valve located in at least one of the first and second exhaust manifolds and moveable to increase the temperature of an exhaust gas by directing exhaust gas from the at least one of first and second exhaust manifolds to the intake manifold;
a first sensor located in the first exhaust manifold to measure a temperature of the exhaust; and
a controller in communication with the first sensor and configured to determine an exhaust temperature based on a signal from the first sensor and move the valve in response to the exhaust temperature being below the minimum operating temperature of the after-treatment device.

17. The power system of claim 16, wherein the minimum operating temperature of the after-treatment device is approximately 200 degrees Celsius.

18. The power system of claim 16, further including a second sensor configured to measure engine speed, wherein the controller is configured to move the valve to increase the temperature of the exhaust gas when the engine speed falls below a threshold speed.

19. The power system of claim 18, wherein the threshold speed is approximately 600 RPM.

20. The power system of claim 16, wherein the after-treatment device is a NOx catalytic device.
